(19) United States
(12) Patent Application Publication
(10) Pub. No.: US 2010/0120655 A1
(43) Pub. Date: May 13, 2010

(54) Clear Aqueous Detergents and Cleaning Agents

(75) Inventors: Ditmar Kischkel, Monheim (DE); Manfred Weuthen, Langenfeld (DE); Thomas Krohnen, Duesseldorf (DE)

Correspondence Address: FOX ROTHSCHILD LLP, 997 Lenox Drive, Bldg. #3, Lawrenceville, NJ, 08648, US

(73) Assignee: COGNIS IP MANAGEMENT GMBH, Duesseldorf (DE)

(21) Appl. No.: 12/524,707

(22) PCT Filed: Dec. 8, 2007
(86) PCT No.: PCT/EP2007/010713

§ 371 Date: Jul. 27, 2009

(30) Foreign Application Priority Data
Jan. 26, 2007 (EP) 07001783.5

(51) Int. Cl. C11D 17/08; C11D 17/00

(52) U.S. Cl. 510/403; 510/437

(57) ABSTRACT

Clear liquid detergents can be produced by adding water-soluble inorganic salts, wherein the agents may comprise non-ionic surfactants, cationic polymers having a charge density of at least 5 meq/g, measured at a pH value of 8, soaps, and anionic surfactants at the same time.

The present invention relates to clear aqueous agents which comprise anionic surfactants and water and also cationic polymers. Such agents are suitable, for example, as detergents or cleaning agents.

Cationic polymers are used in numerous applications such as detergents and cleaning agents, but also cosmetic preparations in order, for example, to achieve effects such as color protection, sensory properties and optical properties on a very wide range of substrates such as fabrics, hair and hard surfaces. However, these polymers cannot be formulated or can be formulated only to a limited degree in combination with anionic surfactants. This means that the use of such polymers in a desired formula is not possible, or formulation compromises have to be made in relation to its properties.

The literature describes a large number of cationic polymers in relation to their use in anionic surfactant-free formulations. The number of publications which disclose a combination of cationic polymers with anionic surfactants is significantly lower and even then they only describe formulations in narrow quantitative ranges, there being a limit of the absolute amount of anionic surfactants in the formulation as well as a limit with regard to a minimal total amount of surface-active components in the formulation. For this, see the application EP 1 645 619 A1 from the applicant, or the international application WO 03/038029. In WO 03/038029, it is moreover assumed that citrates have a destabilizing influence on formulations of anionic surfactant and cationic polymers. WO 01/79404 discloses aqueous liquid detergents which comprise positively charged cationic polymers as well as a mixture of various anionic surfactants, with doubly zwitterionic aminoalkane-sulfonic acids also obligatorily having to be present. U.S. Pat. No. 5,811,386 discloses aqueous agents comprising surfactants, cationic polymers and inorganic salts, where in the example formulations only small amounts of anionic surfactants are present and these agents comprise no soap.

For liquid detergents in particular, however, there is precisely a need to be able to formulate cationic polymer-containing formulations with graduated concentration of the surface-active components in the range from 50-10% by weight whose content of anionic surfactant is greater than 20% by weight based on the surface-active components, which should thus comprise between 2 and 10% by weight of anionic surfactants. The addition of anionic surfactants is desired primarily to improve the detergency. Furthermore, anionic surfactants are superior over other surfactant classes from the point of view of cost. However, it is often the case with relatively highly concentrated agents of this type that clouding of the agent is observed, which is undesired.

It has now been found that stable, clear aqueous agents can be formulated which comprise cationic polymers besides surfactants and optionally soap, where high fractions of anionic surfactants may also be present if selected amounts of certain salts are present.

The first embodiment of the invention therefore relates to a clear agent, which is liquid or gel-like at 21° C., comprising (a) water in amounts of from 20 to 80% by weight, (b) nonionic, cationic and/or amphoteric surfactants in amounts of in total 1 to 70% by weight, (c) cationic polymers in amounts of from 0.01 to 10% by weight, (d) soaps in amounts of from 0 to 15% by weight, (e) anionic surfactants in amounts of from 1 to 25% by weight, (f) 0.1 to 10% by weight of water-soluble salts, and optionally (g) further ingredients, with the proviso that the amounts of components (a) to (g) add up to 100% by weight, where the cationic polymers must have a charge density, measured at pH 8, of at least 5 meq/g.

Cloudiness refers to the property of an aqueous preparation to scatter incident light caused by undissolved, finely disperse substances. Within the context of the present technical teaching, clear agents are therefore those agents which do not have clouding which can be perceived by the human eyes. This can also be measured via the transmission, i.e. the penetrability for light, which the agents have compared to a standard (usually demineralized water). Clear agents therefore have, measured at 500 to 560 nm against demineralized water as standard (=100% transmission), a transmission value of at least 90%, preferably 90 to 99% and in particular 95 to 99%. Here, within the context of the present invention, however, the agents can also be completely colored, provided they are only clear. The agents comprise the components (a) to (c), (e) and (f) as obligatory constituents, whereas the other components (d) and/or (g) are optional ingredients. Quantitative data in % by weight generally always refer to the mass of the total agent as 100% value. The agents are liquid, but can also be in the form of a gel. Their importance and composition are described in detail below:

### (a) Water

Water as component (a) is obligatorily present in amounts of at least 20% by weight, based on the total agent. However, the agents according to the present technical teaching can also be present in a greater or lesser diluted form and then comprise up to 80% by weight of water. However, they preferably comprise less water, for example from 20 to 80% by weight, preferably from 50 to 75% by weight and in particular from 50 to 65% by weight, of water. The range from 50 to 55% by weight of water is particularly advantageous.

(b) Cationic, Amphoteric and/or Nonionic Surfactants

Suitable as component (b) are cationic, amphoteric and/or nonionic surfactants, but preferably nonionic surfactants. In one preferred embodiment, the agents according to the invention comprise exclusively nonionic surfactants as component (b), i.e. they are free from cationic and/or amphoteric surfactants. The surfactants according to component (b) are present in the agents in amounts of from 1 to 70% by weight, but preferably from 5 to 70% by weight. Preference is also given to those agents which comprise nonionic surfactants in amounts of from 10 to 45% by weight, preferably 10 to 25% by weight and in particular in amounts of from 10 to 22% by weight.

Typical examples of nonionic surfactants are fatty alcohol polyglycol ethers, alkylphenol polyglycol ethers, fatty acid polyglycol esters, fatty acid amide polyglycol ethers, fatty amine polyglycol ethers, alkoxylated triglycerides, mixed ethers and/or mixed formals, optionally partially oxidized alk(en)yl oligoglycosides and/or glucuronic acid derivatives, fatty acid N-alkylglucamides, protein hydrolysates (in particular wheat-based vegetable products), polyol fatty acid esters, sugar esters, sorbitan esters, polysorbates and amine oxides. If the nonionic surfactants contain polyglycol ether chains, these can have a conventional homologue distribution, but preferably have a narrowed homologue distribution.

Within the context of the present invention, in particular fatty alcohol alkoxylates, fatty acid alkoxylates or alkyl (oligo)glycosides are suitable as component (b).

As a consequence of the preparation, alcohol ethoxylates are referred to as fatty alcohol ethoxylates or oxo alcohol ethoxylates and preferably conform to the formula (I),

R²O(CH₂CH₂O)ₙH (I)

in which R² is a linear or branched alkyl and/or alkenyl radical having 6 to 22 carbon atoms and n is numbers from 1 to 50, where the range from 3 to 30 and in particular from 3 to 12 may be particularly preferred. Typical examples are the adducts of, on average, 1 to 50, preferably 5 to 40 and in particular 10 to 25 mol, onto e.g. caproic alcohol, caprylic alcohol, 2-ethylhexyl alcohol, capric alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and brassidyl alcohol, and technical-grade mixtures thereof which are produced e.g. during the high-pressure hydrogenation of technical-grade methyl esters based on fats and oils or aldehydes from the Roelen oxo synthesis, and also as monomer fraction in the dimerization of unsaturated fatty alcohols. Preference is also given to adducts of from 10 to 40 mol of ethylene oxide onto technical-grade fatty alcohols having 12 to 18 carbon atoms, such as, for example, coconut, palm, palm kernel or tallow fatty alcohols.

Alkyl and alkenyl oligoglycosides are known nonionic surfactants which conform to the formula (II)

R¹O—[G]ₚ (II)

in which R¹ is an alkyl and/or alkenyl radical having 4 to 22 carbon atoms, G is a sugar radical having 5 or 6 carbon atoms and p is numbers from 1 to 10. They can be obtained by the relevant methods of preparative organic chemistry. The alkyl and/or alkenyl oligoglycosides can be derived from aldoses and/or ketoses having 5 or 6 carbon atoms, preferably glucose. The preferred alkyl and/or alkenyl oligoglycosides are thus alkyl and/or alkenyl oligoglucosides. The index number p in the general formula (II) gives the degree of oligomerization (DP), i.e. the distribution of mono-glycosides and oligoglycosides and is a number between 1 and 10. Whereas p in a given compound must always be a whole number and here in particular can assume the values p=1 to 6, the value p for a specific alkyl oligoglycoside is an analytically determined calculated parameter which in most cases is a fraction. Preference is given to using alkyl and/or alkenyl oligoglycosides with an average degree of oligomerization p of from 1.1 to 3.0. From an applications point of view, preference is given to those alkyl and/or alkenyl oligoglycosides whose degree of oligomerization is less than 1.7 and is in particular between 1.2 and 1.4. The alkyl and/or alkenyl radical R¹ can be derived from primary alcohols having 4 to 11, preferably 8 to 10, carbon atoms. Typical examples are butanol, caproic alcohol, caprylic alcohol, capric alcohol and undecyl alcohol, and technical-grade mixtures thereof as are obtained, for example, in the hydrogenation of technical-grade fatty acid methyl esters or in the course of the hydrogenation of aldehydes from the Roelen oxo synthesis. Preference is given to alkyl (oligo)glucosides of chain length C₈-C₁₀ (DP=1 to 3) which are produced as forerunner in the distillative separation of technical-grade C₈-C₁₈-coconut fatty alcohol and can be contaminated with a fraction of less than 6% by weight of C₁₋₂-alcohol, and also alkyl oligoglucosides based on technical-grade C_{9/11}-oxo alcohols (DP=1 to 3). The alkyl and/or alkenyl radical R¹ can in addition also be derived from primary alcohols having 12 to 22, preferably 12 to 14, carbon atoms. Typical examples are lauryl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol, and technical-grade mixtures thereof which can be obtained as described above. Preference is given to alkyl oligoglucosides based on hydrogenated C_{12/14} coconut alcohol with a DP of from 1 to 3.

Furthermore, surfactants from the class of hydroxyalkyl ethers which conform to the general formula (III) can preferably be used.

R¹O[CH₂CH₂O]ₓCH₂CH(OM)R² (III)

In the formula (III), R¹ is a linear or branched alkyl and/or alkenyl radical having 4 to 22 carbon atoms, or is a radical R²—CH(OH)CH₂, where R² is a linear or branched alkyl and/or alkenyl radical having 8 to 16 carbon atoms, x is a number from 40 to 80, and M is a hydrogen atom or a saturated alkyl radical having 1 to 18 carbon atoms.

Such surfactants, also known as hydroxy mixed ethers, are known from literature and are described, for example, in the German application DE 19738866. They are prepared, for example, by reacting 1,2-epoxyalkanes (R″CHOCH₂), where R″ is an alkyl and/or alkenyl radical having 2 to 22, in particular 6 to 16, carbon atoms, with alkoxylated alcohols. Within the context of the invention, preference is given to those hydroxy mixed ethers which are derived from alkoxylates of monohydric alcohols of the formula R′—OH having 4 to 18 carbon atoms, where R′ is an aliphatic, saturated, straight-chain or branched alkyl radical, in particular having 6 to 16 carbon atoms. Examples of suitable straight-chain alcohols are butanol-1, caproic alcohol, oenanthic alcohol, caprylic alcohol, pelargonic alcohol, capric alcohol, undecanol-1, lauryl alcohol, tridecanol-1, myristyl alcohol, pentadecanol-1, palmityl alcohol, heptadecanol-1, stearyl alcohol, nonadecanol-1, arachidyl alcohol, heneicosanol-1, behenyl alcohol, and technical-grade mixtures thereof as are produced in the high-pressure hydrogenation of technical-grade methyl esters based on fats and oils. Examples of branched alcohols are so-called oxo alcohols which mostly carry 2 to 4 methyl groups as branches and are prepared by the oxo process, and so-called Guerbet alcohols which are branched in the 2 position with an alkyl group. Suitable Guerbet alcohols are 2-ethylhexanol, 2-butyloctanol, 2-hexyldecanol and/or 2-octyldodecanol. The alcohols are used in the form of their alkoxylates which are prepared in a known manner by reacting the alcohols with ethylene oxide. In addition, other hydroxy mixed ethers are also known, namely those which have more than one free hydroxyl group in the molecule. Such compounds can be prepared, for example, by reacting diols, preferably alkylene glycols and derivatives thereof, preferably polyethylene glycols, in each case with 2 mol of an alkyl epoxide (R—CHOCH₂) per mol of the diol.

### (c) Cationic Polymers

The agents according to the invention obligatorily comprise a cationic polymer, which should preferably be water-soluble. In this connection, polymers are to be understood as meaning homopolymers and also copolymers and/or terpolymers. Suitable cationic polymers are, for example, cationic cellulose derivatives, cationic starch, copolymers of diallyl ammonium salts and acrylamides, quaternized vinylpyrrolidone/vinyl-imidazole polymers, condensation products of poly-glycols and amines, copolymers of acrylic acid with dimethyldiallylammonium chloride (Merquat® 550) or polyaminopolyamides.

Preferably, polydiallyldialkylammonium chloride and here in particular polydimethyldiallylammonium chloride is selected as component (c). In this connection, in particular those polymers are selected whose molecular weight is in the range from 1000 to 10 000 000, in particular 1000 to 100 000, where the range from 2000 to 20 000 can be particularly preferred. Within the context of the present invention, polydiallyldialkylammonium compounds are known and commercially available. The alkyl radicals in these polymers can preferably have 1 to 18 carbon atoms, preferably 1 to 4 carbon atoms. Such products preferably have Brookfield viscosities of from 200 to 400 mPas. The active substance content (AS) is typically up to 30 to 50%. Besides the salts, within the context of the present technical teaching, it is also possible in principle to use the copolymers of polydiallyldimethylammonium, in particular copolymers with acrylic acid, methacrylic acid, acrylamides or vinylpyrrolidones.

However, it is decisive that only those polymers are in accordance with the invention whose charge density, measured at pH=8, is at least 5 meq/g and preferably at least 6 meq/g. The charge density is measured by polyelectrolyte titration in an aqueous medium. Furthermore, it may be preferred to use cationic polymers with a charge density, measured at pH=8, which has a value in the range from 5 to meq/g and preferably 5.5 to 8.5 meq/g, where the range from 6.0 to 7.5 may be particularly preferred. Particular preference is given here to polydimethyldiallylammonium chloride which has a charge density of from 6.3 to 6.5 meq/g.

### (d) Soap

The agents according to the invention can comprise soaps, preferably sodium and potassium soaps. However, the ethanolamine salts are in principle also suitable. In this connection, amounts between 1 to 12% by weight, preferably 2 to 10% by weight and in particular in amounts of from 4 to 8% by weight are preferred. Preferably, the potassium soaps and/or particularly preferably the sodium soaps of C₁₂-C₁₈-fatty acids are used. However, preference is also given to soap-free formulations.

### (e) Anionic Surfactants

The agents according to the invention comprise anionic surfactants in amounts of from 1 to 25% by weight. Particular preference is given to those agents which comprise anionic surfactants in amounts of from 5 to 20% by weight, preferably 7 to 20% by weight and particularly preferably in amounts of from 7 to 15% by weight. Furthermore, in general preference is given to those agents which comprise more than 6% by weight of anionic surfactants. Within the context of the present technical teaching, agents with relatively high fractions of anionic surfactants have a tendency to be preferred.

Anionic surfactants which can be used are in principle all representatives of this surfactant class known to the person skilled in the art. Typical examples of anionic surfactants are alkylbenzenesulfonates, alkanesulfonates, olefinsulfonates, alkyl ether sulfonates, glycerol ether sulfonates, α-methyl ester sulfonates, sulfo fatty acids, alkyl sulfates, glycerol ether sulfates, fatty acid ether sulfates, hydroxy mixed ether sulfates, monoglyceride (ether) sulfates, fatty acid amide (ether) sulfates, mono- and dialkyl sulfosuccinates, mono- and dialkyl sulfosuccinamates, sulfo-triglycerides, ether carboxylic acids and salts thereof, fatty acid isethionates, fatty acid sarcosinates, fatty acid taurides, N-acylamino acids, such as, for example, acyl lactylates, acyl tartrates, acyl glutamates and acyl aspartates, alkyl oligoglucoside sulfates, protein fatty acid condensates (in particular wheat-based vegetable products) and alkyl (ether) phosphates. If the anionic surfactants contain polyglycol ether chains, these can have a conventional homologue distribution, but preferably have a narrowed homologue distribution. However, within the context of the present disclosure, soaps are not understood as meaning anionic surfactants (e). Preference is given to alkyl ether sulfates, alkyl sulfates and benzene-sulfonates.

Alkyl and/or alkenyl ether sulfates which are suitable as component (e) are known and industrially available sulfation products of linear fatty alcohols or partially branched oxo alcohols. They preferably conform here to the formula (IV),

RO(CH₂CH₂O)ₙSO₃X (IV)

in which R is a linear or branched alkyl and/or alkenyl radical having 6 to 22 carbon atoms, n is numbers from 1 to 10 and X is alkali metal and/or alkaline earth metal, ammonium, alkylammonium, alkanolammonium or glucammonium. Ether sulfates of the specified type are prepared industrially by sulfation and subsequent neutralization of the corresponding alcohol polyglycol ethers. Typical examples are the sulfates based on addition products of from 1 to 10 and in particular 2 to 5 mol of ethylene oxide onto caproic alcohol, caprylic alcohol, 2-ethylhexyl alcohol, capric alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, linoleyl alcohol, linolenyl alcohol, elaeostearyl alcohol, arachyl alcohol, gadoleyl alcohol, behenyl alcohol, erucyl alcohol, and brassidyl alcohol, and also technical-grade mixtures thereof in the form of the sodium, potassium or magnesium salts.

Alkyl ether sulfates are particularly preferred nonionic surfactants within the context of the present teaching.

Also suitable are the alkyl sulfates. Alkyl and/or alkenyl sulfates, which are also often referred to as fatty alcohol sulfates, are to be understood as meaning the sulfation products of primary alcohols which conform to the formula (V),

R¹O—SO₃X (V)

in which R¹ is a linear or branched, aliphatic alkyl and/or alkenyl radical having 6 to 22, preferably 12 to 18, carbon atoms and X is an alkali metal and/or alkaline earth metal, ammonium, alkylammonium, alkanolammonium or glucammonium. Typical examples of alkyl sulfates which can be used within the context of the invention are the sulfation products of caproic alcohol, caprylic alcohol, capric alcohol, 2-ethylhexyl alcohol, lauryl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, and erucyl alcohol, and technical-grade mixtures thereof which are obtained by high-pressure hydrogenation of technical-grade methyl ester fractions or aldehydes from the Roelen oxo synthesis. The sulfation products can preferably be used in the form of their alkali metal salts and in particular their sodium salts. Particular preference is given to alkyl sulfates based on C_{16/18} tallow fatty alcohols and/or vegetable fatty alcohols of comparable carbon chain distribution in the form of their sodium salts.

A further class of preferably selected anionic surfactants are the alkylbenzenesulfonates (ABS). These preferably conform to the formula R′-Ph-SO₃X in which R′ is a branched, but preferably linear, alkyl radical having 10 to 18 carbon atoms, Ph is a phenyl radical and X is an alkali metal and/or alkaline earth metal, ammonium, alkylammonium, alkanolammonium or glucammonium. Preference is given to using dodecylbenzenesulfonates, tetradecylbenzenesulfonates, hexadecylbenzenesulfonates and technical-grade mixtures thereof in the form of the sodium salts.

### (f) Water-Soluble Salts

According to the invention, the agents receive water-soluble inorganic salts in amounts of from 0.1 to 5% by weight. Water-soluble salts are those which, at 21° C., have a solubility of at least 25 g of salt in 100 ml of water and preferably of at least 30 g of salt per 100 ml of water.

The water-soluble inorganic salts (f) are in particular selected from the group sodium chloride, potassium chloride, sodium sulfate or potassium sulfate and mixtures thereof. It is also possible to use ammonium compounds, e.g. ammonium chloride. Preferably, sodium chloride is selected.

In the claimed amounts, the salts lead to the desired stabilization of the described aqueous agents. The salts are added in amounts of at least 0.1% by weight, based on the total amount of the agent. The upper limit is 5 to at most 10% by weight. The agents advantageously comprise the salts in amounts of from 0.5 to 3% by weight and in particular from 1 to 2.5% by weight. The amount of the salts can vary depending on the nonionic surfactants, anionic surfactants and optionally also the soap present in the formulation.

It is the tendency that with a relatively high content of anionic surfactants, also a relatively large amount of salts is required in order to be able to formulate clear agents. Particularly in the case of anionic surfactant contents greater than 6% by weight, it may be advantageous to stabilize the agents within the context of the present invention with at least 0.5% by weight of salts.

### (g) Other Ingredients

Besides the aforementioned surfactants and ingredients, the agents according to the invention can also have further typical ingredients, such as, for example, inorganic or organic bases or acids, other pH regulators, antifoams, viscosity regulators, biocides, preservatives, enzymes, enzyme stabilizers, perfumes and/or fragrances, dyes, nonaqueous solvents, hydroxycarboxylic acids and/or phosphonates. Further ingredients of this category may be bleaches, bleach boosters, optical brighteners, preservatives and builders.

Auxiliaries and additives are in principle optional—the agents according to the invention can therefore also be completely free from these substances. However, they are preferably present in amounts of from 0.1 to 30% by weight, particularly preferably in amounts of from 1 to 20% by weight and very particularly preferably in amounts of from 5 to 15% by weight—based on the total amount of the agent.

Suitable organic solvents are, for example, mono- and/or polyfunctional alcohols having 1 to 6 carbon atoms, preferably having 1 to 4 carbon atoms. Preferred alcohols are ethanol, 1,2-propanediol, glycerol, and mixtures thereof, but also glycol and oligo- and/or polyglycols that are liquid at room temperature (=21° C.). The agents preferably comprise 2 to 20% by weight and in particular 5 to 15% by weight of ethanol or any desired mixture of ethanol and 1,2-propanediol or in particular of ethanol and glycerol. It is likewise possible that the preparations comprise, either additionally to the mono- and/or polyfunctional alcohols having 1 to 6 carbon atoms or alone, polyethylene glycol with a relative molecular mass between 200 and 2000, preferably up to 600, in amounts of from 2 to 17% by weight. Hydrotropes which can be used are, for example, toluenesulfonate, xylenesulfonate, cumenesulfonate or mixtures thereof.

Viscosity regulators which can be used are, for example, hydrogenated castor oil, salts of long-chain fatty acids, which are preferably used in amounts of from 0 to 5% by weight and in particular in amounts of from 0.5 to 2% by weight, for example sodium, potassium, aluminum, magnesium and titanium stearates or the sodium and/or potassium salts of behenic acid, and also further polymeric compounds. Other suitable thickeners are polymeric thickeners e.g. based on xanthan or polyacrylates or cellulose derivatives such as CMC.

Suitable enzymes are those from the class of proteases, lipases, amylases, cellulases and mixtures thereof. Enzymatic active ingredients obtained from bacteria strains or fungi, such as Bacillus subtilis, Bacillus lichenifonnis and Streptomyces griseus, are particularly highly suitable. Preference is given to using proteases of the subtilisin type and in particular proteases obtained from Bacillus lentus. Their fraction can be about 0.2 to about 2% by weight. The enzymes can be adsorbed to carrier substances and/or embedded in coating substances in order to protect them against premature decomposition. In addition to the mono- and polyfunctional alcohols and the phosphonates, the agents can have further enzyme stabilizers. For example, 0.5 to 1% by weight of sodium formate can be used. The use of proteases which are stabilized with soluble calcium salts and a calcium content of preferably about 1.2% by weight, based on the enzyme, is also possible. However, the use of boron compounds, for example of boric acid, boron oxide, borax and other alkali metal borates such as the salts of orthoboric acid (H₃BO₃), of metaboric acid (HBO₂) and of pyroboric acid (tetraboric acid H₂B₄O₇), is particularly advantageous.

Suitable non-surfactant-like foam inhibitors are, for example, organopolysiloxanes and mixtures thereof with microfine, optionally silanized silicic acid and also paraffins, waxes, microcrystalline waxes and mixtures thereof with silanized silicic acid or bistearyl-ethylenediamide. Mixtures of different foam inhibitors, e.g. those of silicones, paraffins or waxes, are also used with advantages.

Furthermore, the agents can comprise hydroxycarboxylic acids, in particular tartrates and/or citrates, e.g. as builders or for the regulation of the pH, in amounts up to 10% by weight. The agents of the invention preferably comprise hydroxycarboxylic acids in amounts between 1 and 5% by weight, preferably between 1.5 and 3% by weight. Citrates are particularly preferred here. Derivatized hydroxycarboxylic acid, e.g. alkoxylated hydroxycarboxylic acids, can also be used.

The pH of the agents according to the invention is generally 7 to 10.5, preferably 7 to 9.5 and in particular 7 to 8.5. Higher pH values, for example above 9, can be established through the use of small amounts of sodium hydroxide solution or of alkaline salts such as sodium carbonate or sodium silicate. However, it is also possible to formulate weakly acidic agents whose pH values are in the range from 6 to 7, preferably in the range from 6.5 to 7.5.

The agents within the context of the invention are liquid or gel-like at 21° C. Liquid agents may be preferred. The agents of the invention preferably have viscosities (in accordance with Happier, measured at 20° C.) of preferably 5000, but in particular from 10 000 to at most 50 000 mPas and in particular from 15 000 to at most 50 000 mPas, where also the low-viscosity range from 50 to 5000 and here the range from 1000 to 5000 mPas may be preferred. Gels are to be understood here as meaning three-dimensionally stable, readily deformable disperse systems of at least two components which mostly consist of a solid, colloidally divided substance with long or heavily branched particles (e.g. gelatin, silicic acid, montmorillonite, bentonites, polysaccharides, pectins and other thickeners) and a liquid (in most cases water) as dispersant. Here, the solid substance is coherent, i.e. it forms a spatial network within the dispersant where the particles adhere to one another by virtue of secondary valences or main valences at various points (adhesion points).

The preparation of the agents takes place in a manner known to the person skilled in the art. For example, firstly the water is initially introduced, together with pH regulators and solvents. Subsequently, the surfactants and then the remaining ingredients are added. In order to ensure soap formation, the mixture can be admixed with fatty acids, then rendered alkaline and heated (to ca. 60 to 80° C.) and then the soaps are formed in situ by adding the surfactants.

A further embodiment of the invention relates to the use of water-soluble salts for the stabilization of aqueous liquid detergents which comprise anionic surfactants, nonionic surfactants, cationic polymers and optionally soap alongside one another. The stabilization leads here to the avoidance of cloudiness, meaning that the salt addition also prevents the clouding of the described agents. Preference is given to using: sodium chloride, potassium chloride, sodium sulfate, ammonium chloride and ammonium sulfate, or any desired mixtures thereof. Sodium chloride is particularly preferred. The amounts of salt correspond to the aforementioned values for the liquid agents. In one preferred embodiment, those agents are preferably to be stabilized which have cationic polymers with a charge density, measured at pH=8, of at least 5 meq/g. Furthermore, preference is given to those cationic polymers which have charge densities in the range from preferably 5.5 to 8.5 meq/g, where the range from 6.0 to 7.5 is further preferred.

The stabilization according to the invention relates in particular to agents as described above which thus comprise the components (a) to (g) in the disclosed amounts and grades. To be emphasized here is the teaching that as a result of the salt addition, stable, clear liquid detergents can be formulated which comprise the cationic polymers of said charge density as well as anionic surfactants, preferably in amounts of more than 5% by weight and preferably more than 8% by weight and in particular more than 12% by weight. The teaching of the present application also leads to agents which have good storage stability at high and low storage temperatures.

### EXAMPLES

Several aqueous, liquid cleaning agents were prepared by mixing the ingredients. Here, the agents A1 to A6 according to the invention were compared with those formulations which were free from electrolyte salts. The agents were prepared as follows: water, NaOH, fatty acid and propylene glycol were initially introduced and then heated to 70° C. with stirring. The surfactants and the cationic polymer were then added with stirring after switching off the heating. After the mixture had cooled to 40° C., borax, Dequest 2066, citric acid and ethanol were added. The pH was then adjusted to 9 using NaOH/citric acid, followed by the addition of NaCl to clarify the formulation and the addition of enzymes and preservatives. The agents were then assessed visually for transparency. It was found that by adding the electrolyte salts it was possible to formulate clear, liquid agent with a considerably higher fraction of anionic surfactants than without this addition. The composition of the agents is given in table 1. All of the data here refers to the content of active substance. The following ingredients designated by their trade names were used:

| | |
|---|---|
| Maranil A 55 | Sodium n-alkylbenzenesulfonate (Cognis) |
| Dehydol LT7 | Fatty alcohol mixture (C12/C18) with on |
| | average 7 parts of ethylene oxide per |
| | part of fatty alcohol (Cognis) |
| Polyquart FDI | Polydimethylallylammonium chloride, Cognis |
| Dequest 2066 | Preservative phosphonate, Solutia |
| Microcare IT | Preservative |

TABLE 1

| | C1 | A1 | A2 | C2 | A3 | A4 |
|---|---|---|---|---|---|---|
| Water | 54.93 | 54.43 | 52.93 | 55.89 | 54.89 | 52.29 |
| NaOH | 3.37 | 3.37 | 3.37 | 2.35 | 2.35 | 2.35 |
| Soap | 8.9 | 8.9 | 8.9 | 3.56 | 3.56 | 3.56 |
| Propylene glycol | 5 | 5 | 5 | 5 | 5 | 5 |
| Maranil A 55 | 10 | 10 | 14 | 7.8 | 7.8 | 13 |
| Dehydol LT 7 | 10 | 10 | 6 | 17.6 | 17.6 | 13 |
| Polyquart FDI | 0.1 | 0.1 | 0.1 | 0.1 | 0.1 | 0.1 |
| NaCl | 0 | 0.5 | 2 | 0 | 2 | 3 |
| Ethanol | 3 | 3 | 3 | 3 | 3 | 3 |
| Borax (20% AS) | 0.2 | 0.2 | 0.2 | 0.2 | 0.2 | 0.2 |
| Dequest 2066 | 0.4 | 0.4 | 0.4 | 0.4 | 0.4 | 0.4 |
| Citric acid | 3 | 3 | 3 | 3 | 3 | 3 |
| Microcare IT | 0.1 | 0.1 | 0.1 | 0.1 | 0.1 | 0.1 |
| Amylase | 0.5 | 0.5 | 0.5 | 0.5 | 0.5 | 0.5 |
| Protease | 0.5 | 0.5 | 0.5 | 0.5 | 0.5 | 0.5 |
| Appearance | cloudy | clear | clear | cloudy | clear | clear |
| % transmission | 87.9 | 99.2 | 98.7 | 15.4 | 98.3 | 98.8 |

| | C3 | A5 | A6 |
|---|---|---|---|
| Water | 54.93 | 54.43 | 51.93 |
| NaOH | 3.37 | 3.37 | 3.37 |
| Edenor K1218 | 8.9 | 8.9 | 8.9 |
| Propylene glycol | 5 | 5 | 5 |
| Texapon N 70 | 6 | 6 | 16 |
| Dehydol LT 7 | 14 | 14 | 4 |
| Polyquart FDI | 0.1 | 0.1 | 0.1 |
| Salt addition | 0 | 0.5 | 3 |
| Ethanol | 3 | 3 | 3 |
| Borax (20% AS) | 0.2 | 0.2 | 0.2 |
| Dequest 2066 | 0.4 | 0.4 | 0.4 |
| Citric acid | 3 | 3 | 3 |
| Microcare IT | 0.1 | 0.1 | 0.1 |
| Amylase | 0.5 | 0.5 | 0.5 |
| Protease | 0.5 | 0.5 | 0.5 |
| Appearance | cloudy | clear | clear |
| % transmission | 80.5 | 99.1 | 96.6 |

The appearance of the agents was assessed visually. The values for the transmission were measured using a UV-VIS spectrometer Varian Cary 4 with 1 cm QS cuvettes against demineralized water (=100% transmission) in the wavelength range 500-650 nm at 22° C. (scan speed: 120 nm/min; split 0.2 nm).

What is claimed is:

1. A clear agent, which is liquid or gel-like at 21° C., comprising:
(a) 20 to 80% by weight of water,
(b) 1 to 70% by weight of at least one surfactant selected from the group consisting of nonionic surfactants, cationic surfactants, amphoteric surfactants and combinations thereof,
(c) 0.01 to 10% by weight of at least one cationic polymer,
(d) optionally, 0 to 15% by weight of at least one soap,
(e) 1 to 25% by weight of at least one anionic surfactants,
(f) 0.1 to 10% by weight of at least one water-soluble inorganic salt, and
(g) optionally further ingredients, with the proviso that the amounts of components (a) to (g) add up to 100% by weight,
wherein said cationic polymer has a charge density, measured at pH 8, of at least 5 meq/g.

2. The agent of claim 1, comprising water in an amount of from 50 to 75% by weight.

3. The agent of claim 1, comprising exclusively nonionic surfactants as component (b).

4. The agent claim 1, wherein said nonionic surfactants are selected from the group consisting of fatty alcohol alkoxylates, hydroxyalkyl ethers, alkyl (oligo)glycosides and combinations thereof.

5. The agent of claim 1, wherein the total of said nonionic surfactants is from 2 to 45% by weight.

6. The agent of claim 1, wherein component (c) comprises polydimethyldiallylammonium chloride.

7. The agent of claim 1, comprising said soap (d) in an amount of from 1 to 12% by weight.

8. The agent of claim 1, wherein said anionic surfactants (e) are selected from the group consisting of alkyl sulfates, alkyl ether sulfates, alkylsulfonates, benzenesulfonates, and combinations thereof.

9. The agent of claim 1, wherein the total of said anionic surfactants (e) is from 5 to 20% by weight.

10. The agent of claim 1, wherein said water-soluble salts (f) are selected from the group consisting of sodium chloride, potassium chloride, sodium sulfate, potassium sulfate and mixtures thereof.

11. The agent of claim 1, wherein the total of said water-soluble salts is from 0.1 to 5% by weight.

12. The agent of claim 1, wherein the total of said components (g) is from 0.1 to 30% by weight.

13. The agent of claim 1, wherein said components (g) are selected from the group consisting of inorganic bases, organic bases, inorganic acids, organic acids, antifoams, viscosity regulators, biocides, preservatives, enzymes, enzyme stabilizers, perfumes, fragrances, nonaqueous solvents, hydroxycarboxylic acids, phosphonates, and combinations thereof.

14. A method of stabilizing aqueous liquid detergents which comprise anionic surfactants, nonionic surfactants, and/or cationic polymers having a charge density measured at pH=8 of at least 5 meq/g, and optionally soap, said method comprising adding at least one water-soluble salt.

15. The method of claim 14, wherein said salts are selected from the group consisting of sodium chloride, potassium chloride, sodium sulfate, ammonium chloride, ammonium sulfate, and mixtures thereof.

16. The agent of claim 1, wherein the total of said nonionic surfactants is from 10 to 22% by weight.

17. The agent of claim 1, comprising said soap (d) in an amount of from 4 to 8% by weight.

18. The agent of claim 1, wherein the total of said anionic surfactants (e) is from 7 to 15% by weight.

19. The agent of claim 1, wherein said water-soluble salt (f) is sodium chloride

20. The agent of claim 1, wherein the total of said water-soluble salts (f) is from 1 to 2.5% by weight.
